(19) United States
(12) Patent Application Publication
(10) Pub. No.: US 2013/0156970 A1
(43) Pub. Date: Jun. 20, 2013

(54) Method to Create Uniform Distribution, Minimize Applied Solution Volume and Control Droplet Size of Water and/or Coating Applications for Web Applications

(71) Applicant: Jonathan Crawford, Vancouver (CA)

(72) Inventor: Jonathan Crawford, Vancouver (CA)

(73) Assignee: Honeywell ASCa Inc., Mississauga (CA)

(21) Appl. No.: 13/326,602

(22) Filed: Dec. 15, 2011

(51) Int. Cl. B05D 1/04; B05C 11/00; B05D 5/00; B05B 5/00

(52) U.S. Cl. 427/469; 118/621; 239/690

(57) ABSTRACT

A coating apparatus produces a spray of charged droplets and controls the spray angle of travel of the spray toward the object to be coated. Electrically charging droplets minimizes the amount of coating material required to uniformly coat a surface as compared to conventional web coating techniques such as blade coating. An inductive ring guides the spray charged droplets as they exit the nozzle of a spray device. The electrostatic repulsion between the charged droplets insures that a uniform coating of liquid formulation can be applied to a web surface.

### FIELD OF THE INVENTION

The present invention generally relates to techniques for controlling the amount of a coating that is applied on paper sheet or other web products, and in particular to a device that generates charged coating droplets that are sprayed in a controlled manner onto the web to create a uniform distribution of the coating.

### BACKGROUND OF THE INVENTION

In the process of papermaking, it is often desirable to coat a paper sheet (called a “base sheet”) with any of a wide variety of materials. Indeed, an increasing proportion of the world's paper production is devoted to coated paper and coated paperboard. Coatings are usually applied to provide a glossy white surface for magazine pages, gift-wrapping, shoeboxes, and the like. Alternatively, or in addition, such coatings may also be intended to render the paper sheet waterproof. As another example of a coating material, microencapsulated ink may be applied as a coating to one side of a sheet of carbonless copy paper.

Coatings may be applied to paper as part of the papermaking process in a paper mill. Alternatively, previously manufactured paper may be supplied to the coating machine, called a “coater”, from large rolls of paper sheet. In either event, the uncoated paper is usually supplied to the coater in sheets that are on the order of 3 meter or more in width measured along the “cross-direction” (i.e., the direction transverse to the direction of movement of the paper along the papermaking and/or coating machine).

Uniformity of coating “basis weight” the mass of the coating material on a unit of surface area of the sheet) is often necessary or desirable for various reasons. For example, the printability of glossy paper may be improved by the uniform application of a gloss coating. Also, gloss coatings may contain relatively expensive materials, such as latex and/or TiO₂. Accordingly, the manufacturer will want to precisely monitor the coating and control the application of such coating to apply as uniform a coating as possible. In some cases, the evenness of the coating must be controlled within a fraction of a gram/m². However, because of the lateral extent of the sheet in the cross-direction (3 meters or more) and the requirement of accurately and evenly applying a coating to such sheets, rather complex coaters have been designed and manufactured.

Coaters come in a variety of configurations. One type of coater, called a “blade coater”, comprises a rotating backing drum disposed adjacent to one side of a moving paper sheet and a flexible blade disposed adjacent to the opposite side of the sheet. The drum and blade edge extend in the cross-direction of the sheet to form a narrow slot through which the sheet of paper passes. A pool of coating material is retained between the backing drum and the blade, and thus coats the sheet as it passes therebetween. The blade presses against the paper with the coating applied as the sheet exits through the slot, thereby removing excess coating.

It will be appreciated that the separation of the drum from the blade edge is a critical factor in the application of such coatings. The drum is fabricated and installed to high tolerances. To control the thickness of the coating applied to a sheet, coaters provide actuators for adjusting the pressure of the blade edge against the coated sheet, and/or the position of the blade edge relative to the drum. The blade is usually made of a thin steel member that may be slightly bent or flexed. Thus, actuators are installed at intervals alone the length of the blade, such that each actuator controls the pressure applied by the blade in the vicinity of the actuator, and therefore, the amount of coating material on the base sheet. The cross-directional length of the blade in the vicinity of each actuator is known as a “slice”. Local variations in blade pressure and paper thickness, and other factors tend to produce uneven coatings. Even distribution of coating on paper and other web coating applications is difficult to achieve. Often, in order to form uniform coatings, excessive coating (or over spray) or non-ideal coating distribution must be applied.

### SUMMARY OF THE INVENTION

The present invention is based, in part, on the recognition that electrically charging droplets in a spray in a coating process will minimize the amount of coating material required to uniformly coat a surface as compared to conventional web coating techniques such as blade coating. The invention provides a method of controlling the droplet size; moreover, the equally charged droplets that are generated exert electrostatic repulsive forces which facilitate their uniform distribution and in the process of being directed toward the surface of a web, the droplets will adhere to the surface of the web and the resulting coating will exhibit the required pattern over a web surface. While the invention will be illustrated with respect to coating paper, it is understood that the device can be employed to coat any object, and web products in particular, where uniform distribution of the coating is required.

In one aspect, the invention is directed to an apparatus for producing a spray of charged droplets of a liquid that includes:
(a) a source of the liquid;
(b) means for atomizing the liquid to produce a spray of droplets;
(c) means for controlling the flow of the liquid through the atomizing means;
(d) means for imparting a charge on the liquid and/or the spray of droplets; and
(e) means for controlling the spray angle of travel of the spray of charged droplets.

In another aspect, the invention is directed to an apparatus for coating a web that is moving in the machine direction that includes:
(a) one or more spray devices that are positioned adjacent to a surface of the web along a cross direction to the web wherein each spray device produces a spray of charged droplets of a liquid directed at the surface, wherein each device includes
(i) means for atomizing the liquid to produce a spray of droplets;
(ii) means for imparting a charge on the liquid and/or the spray of droplets; and
(iii) means for controlling the spray angle of travel of the spray of charged droplets; and
(b) a source of liquid that supplies liquid to the spray devices.

In a further aspect, the invention is directed to a method of distributing a liquid along the length of a moving web that is guided by a continuous rotatable roll that includes the steps of:
(a) generating a spray containing charged droplets of the liquid;
(b) directing the spray onto a surface of the moving web; and
(c) maneuvering the direction of the spray to distribute the droplets in a desired pattern on the surface along the length of the moving web.

### BRIEF DESCRIPTION OF THE DRAWINGS

FIG. 1 depicts a nozzle device for generating a spray of charged droplets;

FIGS. 2 and 3 illustrate a system for coating webs with a plurality of spray devices amounted adjacent a rotatable roller supported a web; and

FIG. 4 illustrates a coating process at the dry end of a papermaking machine with cross directional monitoring of the coating profile.

### DESCRIPTION PREFERRED EMBODIMENTS

FIG. 1 shows an embodiment of a spray apparatus 2 for producing a spray 20 of charged droplets 22 of a liquid that is to be uniformly distributed onto a surface to be coated. Apparatus 2 includes a spray mechanism 4 that is equipped with nozzle 8 having an aperture through which a spray 20 of charged or non-charged droplets 22 is continuously emitted. Suitable spray devices and nozzles that atomize liquids by air or hydraulic pressure into droplets are described, for example, in U.S. Pat. Nos. 4,215,818 to Hopkinson, 4,887,770 to Wacker et al. and 6,334,579 to Zarbi, which are incorporated herein by reference.

The outer contour of spray 20 is preferably cone-shaped with the individual droplets 22 being evenly distributed within the inner region of the cone. Because the droplets 22 are electrically charged at the same polarity they will repel each other. It is understood that the shape of spray 20 can be modified as desired depending on how the liquid coating is to he applied. For instance, the spray can be generated as a linear jet stream, a two-dimensional fan, or other arrangement by changing the nozzle aperture configuration.

The liquid to be sprayed is supplied via channel 10 to the spray device where the liquid flow rate can be regulated by conventional means including pressure controller 6 and flow regulator valve 26. One method of forming electrically charged droplets 22 is by charging the liquid by conduction prior to its being delivered to spray mechanism 4. For example, as shown in FIG. 1, a d.c. voltage generator 48 applies an electrical potential to the liquid prior to being atomized. In this fashion, aperture 8 emits a spray 20 of electrically charged droplets 22. The size or diameter of the droplets is determined in part by the nozzle sizes in spray mechanism 4 and the level of air or hydraulic pressure employed with smaller droplets being generated at higher pressures. When the spray medium is water the majority of the droplets will preferably range from 15 to 50 microns in size. The droplet size will also depend on the material properties of the fluid being atomized.

Alternatively, the spray mechanism 4 can be configured to emit a spray 4 of non-charged droplets 22 that are subsequently charged by induction. In a preferred embodiment as illustrated in FIG. 1, an inductive element (or electrode) 14 which has a metal annular or ring-shaped distal portion 16 is positioned adjacent nozzle 8 so that the spray of droplets traverses through the ring. The inductive element 14 and the metallic lip that forms aperture 8 are connected to a d.c. voltage potential generator 28 so that as non-charged droplets are emitted from aperture 8, the droplets develop an electrical charge as they are exposed to the electric field produced in the gap between the lip and the inductive element 14. The size of droplets 22 in this case is also influenced by the electric field strength with smaller sizes being produced at higher strengths.

The inductive element 14 also serves to control the spray angle so that the droplets 22 can be directed toward different directions as desired. In this regard, a drive mechanism 28, that maneuvers inductive element 14 and which is supported on platform 12, can comprise servomotors, linear or electromagnetic actuators. The inductive element's potential has a polarity that is either equal to or opposite that of the discharged droplets. As is apparent, this spray angle control mechanism can also be used to change the angle of spray 40 even in the configuration where the charged droplets are generated from charged liquids. The spray angle mechanism can also be moved linearly in the direction of the spray flow to change the proximity of the inductive ring to the spray droplets. In each case, the inductive element 14 allows spray patterns to be manipulated as desired. This can be accomplished, for instance, by tilting the position of inductive element 14 and thereby alter the spray angle: In addition, the current through inductive element 14 can be increased or decreased to change the electric field strength. When the inductive element is at the same polarity as that of the charged droplets, the higher current will cause greater repulsion of the charged droplet particles and result in a smaller cone shaped spray. This method works with any form of atomized spray that is charged by induction or conduction.

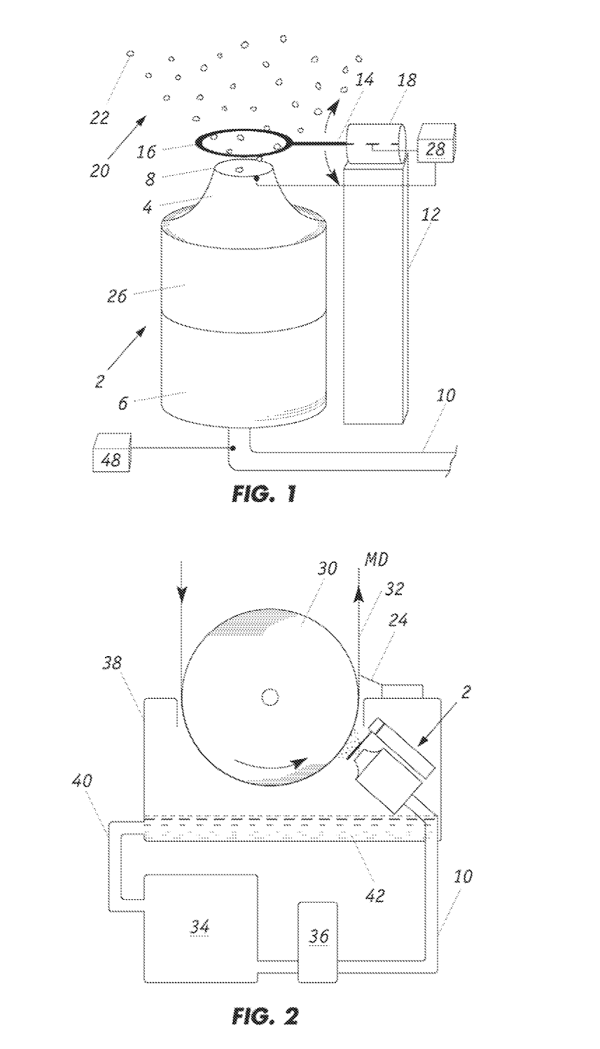

FIG. 2 shows the positioning of spray apparatus 2 adjacent to a web 32 that is supported and guided by rotatable roller 30 as web 32 moves in the machine direction (MD). The spray apparatus 2 is situated within the interior of housing 38 that defines a chamber into which excess liquid coating 42 is collected and recycled via channel 40 back into a liquid source 34 for reused. During operation, pump 36 continuous delivers a liquid via channel 10 into the spray apparatus 2 that distributes a pattern of the coating onto the surface of web 32. Optionally, a blade 24 is positioned downstream of spray apparatus 2 to remove excess coating from the web surface.

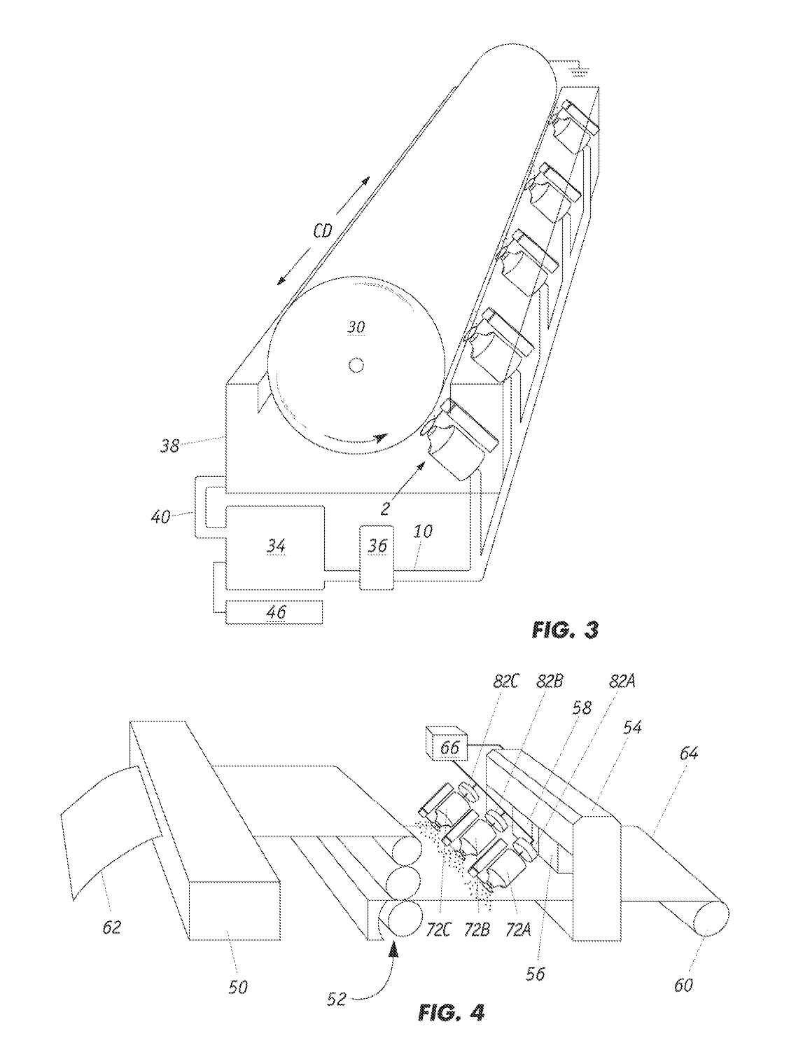

FIG. 3 shows a plurality of spray apparatuses 2 that are positioned along the cross direction (CD) adjacent roller 30 and that directs a corresponding set of spray overlapping patterns toward the roller. As the web (not shown) travels pass the plurality of spray apparatuses 2, a coating having the desired pattern is formed on the surface. Typically, the pattern will be a uniform distribution of the coating along the cross direction although the spray apparatuses can be configured to distribute specific patterns as desired. A liquid from source 34 is supplied by pump 36 via channel 10 to the plurality of spray apparatuses 2. In this arrangement, a source of d.c. voltage generator 46 is connected to source 34 liquid so that the droplets are charged as they exit each spray apparatus. Alternatively, the electric potential can be connected to pump 36 or other suitable device in the liquid flow process. It is critical that the charged liquid from source 34 be electrically isolated from the rest of the system as the liquid is pumped to the spray apparatuses 2. The rotatable roller 30 can be grounded so that the charged droplet particles will not he expelled from the web surface.

The spray apparatus 2 can be employed to spray any suitable liquid based formulation that will form droplets that can maintain a stable electric charge. Preferred formulations are electrically conductive and preferably comprise water or aqueous solutions and mixtures. For paper applications, water is often applied at different stages of the papermaking process. In addition, there is a large variety of coating formulations, many of which consist of as many as ten or more components. These components can be broadly classified as pigments, binders, and additives, almost always as aqueous dispersions. Various formulations of latexes are used for binders to hold the pigment particles together and to bond them to the paper. A typical coating formulation includes 80% to 90% pigment, 3% to 10% latex, with the remainder consisting of additives or other components.

As shown in FIG. 4, typical industrial papermaking machines include a “wet end” or “forming” portion that transforms wet stock into a partially dried sheet of paper 62 that proceeds into a dryer 50. From the dryer, the paper continues downstream into the “dry end” that includes, among operations, a calendaring stack 52 and reel 60. A plurality of spray apparatuses 72A, 72B and 72C, that are regulated by corresponding actuators 82A, 82B and 82C, respectively, is positioned along the cross direction in an unsupported region between the calendaring stack 52 and reel 60 and coats the upper surface of the paper as it passes by. A scanning sensor, that includes an optical source 56 and an optical detector 58, which is supported on supporting frame 54, continuously traverses the sheet and measures properties of finished coated sheet 64 in the cross-direction. Multiple stationary sensors could also be used. Scanning sensors are known in the art and are described, for example, in U.S. Pat. Nos. 6,074,483 to Belotserkovsky et al., and 7,494,567 to Haran, which are incorporated herein by reference. The finished sheet product 64 is then collected on reel 60.

Actuators 82A, 82B and 82C control the distribution of the coating along the cross direction. Measured data from sensors 56, 58 are communicated to controller 66 that calculates control actions for the actuators in order to minimize the variation of the measured properties data from a desired target. For example, if the measured CD coating profile deviates from a target, appropriate control actions are communicated to at least one of the actuators to changes its spray angle, droplet size, droplet volume and/or other parameters.

The foregoing has described the principles, preferred embodiments and modes of operation of the present invention. However, the invention should not be construed as being limited to the particular embodiments discussed. Thus, the above-described embodiments should be regarded as illustrative rather than as restrictive, and it should be appreciated that variations can be made in those embodiments by workers skilled in the art without departing from the scope of the present invention as defined by the following claims.

What is claimed is:

1. An apparatus for producing a spray of charged droplets of a liquid that comprises:
(a) a source of the liquid;
(b) means for atomizing the liquid to produce a spray of droplets;
(c) means for controlling the flow of the liquid through the atomizing means;
(d) means for imparting a charge on the liquid and/or the spray of droplets; and
(e) means for controlling the spray angle of travel of the spray of charged droplets.

2. The apparatus of claim 1 wherein the means for controlling the spray angle of travel of the charged droplets comprises a conductive element disposed at a location traversed by the spray and a first potential source that applies a first electrical potential to the conductive element.

3. The apparatus of claim 2 wherein the first electrical potential has a polarity that is either equal to or opposite that of the charged droplets.

4. The apparatus of claim 2 where the conductive element defines an aperture through which the spray travels.

5. The apparatus of claim 4 wherein the conductive element has an annular configuration.

6. The apparatus of claim 2 wherein the means for controlling the spray angle of travel of the charged droplets includes means for moving the conductive element to change the angle of the direction of travel of the spray of charged droplets.

7. The apparatus of claim 2 wherein the means for controlling the spray angle of travel of the charged droplets includes means for changing the level of current flowing through the conductive element.

8. The apparatus of claim 1 wherein the means for atomizing the liquid comprises a nozzle configured to generate a spray of droplets.

9. The apparatus of claim 7 wherein the nozzle is coupled to a second source of electric potential so that the nozzle generates a spray of charged droplets.

10. The apparatus of claim 1 comprising a third potential source that applies an electrical potential to the liquid prior to being atomized.

11. The apparatus of claim 1 wherein the liquid is selected from the group consisting of water, aqueous solutions and aqueous mixtures.

12. An apparatus for coating a web that is moving in the machine direction that comprises:
(a) one or more spray devices that are positioned adjacent to a surface of the web along a cross direction to the web wherein each spray device produces a spray of charged droplets of a liquid directed at the surface, wherein each device includes
(i) means for atomizing the liquid to produce a spray of droplets;
(ii) means for imparting a charge on the liquid and/or the spray of droplets; and
(iii) means for controlling the spray angel of travel of the spray of charged droplets; and
(b) a source of liquid that supplies liquid to the spray devices.

15. The apparatus of claim 12 wherein each of the one or more spray devices coats the web surface with a discrete pattern of the liquid.

14. The apparatus of claim 12 wherein the web is supported on a rotatable roll.

15. The apparatus of claim 14 comprising one or more blades that remove excess coating from the surface.

16. The apparatus of claim 12 comprising a plurality of spray devices that are configured to be positioned along the length of the rotatable roll.

17. A method of distributing a liquid along the length of a moving web that is guided by a continuous rotatable roll that comprises the steps of:
(a) generating a spray containing charged droplets of the liquid;
(b) directing the spray onto a surface of the moving web; and
(c) maneuvering the direction of the spray to distribute the droplets in a desired pattern on the surface along the length of the moving web.

18. The method of claim 17 further comprising the step of removing excess liquid from the surface.

19. The method of claim 17 further comprising the step of electrically grounding the rotatable roll.

20. The method of claim 17 wherein the web comprises paper and the liquid is selected from the group consisting of water, aqueous solutions, and aqueous mixtures.
